(19) United States
(12) Patent Application Publication
(10) Pub. No.: US 2015/0353200 A1
(43) Pub. Date: Dec. 10, 2015

(54) Aircraft Seat and Holding Device

(71) Applicant: LUFTHANSA TECHNIK AG, HAMBURG (DE)

(72) Inventors: Oliver Thomaschewski, Norderstedt (DE); Frank Klatt, Norderstedt (DE)

(21) Appl. No.: 14/473,604

(22) Filed: Aug. 29, 2014

(30) Foreign Application Priority Data
Jun. 6, 2014 (DE) 10 2014 210 861.6

(51) Int. Cl. B64D 11/06; F16B 45/04

(52) U.S. Cl. CPC B64D 11/0638; B64D 11/06; F16B 45/04

(57) ABSTRACT

Embodiments of the invention elate to an aircraft seat incorporating a holding device, such as a drink holder and a holding device, such as a drinker holder. In specific embodiments, the holding device allows an improved retention of receptacles having a stem, a bowl, and a foot. According to specific embodiments, the holding device incorporates a holding plate that has a recess for receiving the receptacle in the region of the bowl, at least one peripheral region of the recess extending as far as an edge of the holding plate, the holding plate being arranged in the use position such that the recess is freely accessible.

### RELATED APPLICATION

The application claims priority under 35 U.S.C. §119(e) of German Patent Application No. DE 10 2014 210 861.6, filed on Jun. 6, 2014, which is hereby incorporated by reference in its entirety.

### BACKGROUND OF INVENTION

The invention relates to an aircraft seat incorporating a holding device, such as a drink holder and to a holding device, such as a drink holder.

Aircraft seats typically have different functionalities which can be used by a passenger sitting in the aircraft seat. In differing cabin layouts, the aircraft seat is spatially arranged at a relatively great spacing from further aircraft seats in the cabin of an aircraft. For example, this is the case in VIP layouts of aircraft where it is not possible to use the adjacent seats to site the different functionalities. In this respect, it is generally known to provide an aircraft seat with a drink holder.

Typical drink holders on aircraft seats are constructed such that they have a generally cylindrical receiving space in which a receptacle can be held; this is what is known as a cup holder. The base of such cup holders secures the receptacle downwards in a vertical direction, while a wall prevents the receptacle from slipping horizontally. Since high accelerations can occur in aircraft, particularly during takeoff and landing, but also in the case of turbulence, the wall of the drink holder must be high enough to ensure that the receptacle is held securely in the cup holder. This results in a vertical expanse of the cup holder which does not meet the visually aesthetic demands of a premium aircraft layout and has a corresponding installation space requirement. The typical cup holder does not afford any security against the receptacle slipping out upwards in a vertical direction.

Furthermore, integration of the cup holder into an aircraft seat is very difficult due to the vertical expanse of the holder. In this respect, storing the drink holder in a mount in the aircraft seat, for example, is only possible by a complex construction of the cup holder itself or of the holding device with a plurality of cooperating parts which can lead to wear and thereby to increased expense during maintenance.

Drink holders known from the prior art are primarily suitable for receptacles such as cylindrical glasses, bottles or coffee cups which have a relatively low centre of gravity due to the mass distributed towards the planar base. Particularly in premium classes, passengers are also served drinks in receptacles which have a stem, a bowl and a foot; this category of receptacles includes, for example, champagne glasses or wine glasses. These receptacles are relatively tall and narrow due to the stem and to the bowl arranged thereabove. Furthermore, the bowl arranged above the stem produces an elevated centre of gravity which leads to an increased tilting tendency of the receptacle. Therefore, a receptacle of this type would easily slip or tilt in the receiving space of a drink holder according to the prior art, for example in a cup holder.

Thus, prior art aircraft seats with drink holders are not suitable for securely holding a receptacle which has a stem, a bowl, and a foot.

### BRIEF SUMMARY

Embodiments of the invention elate to an aircraft seat incorporating a holding device, such as a drink holder and a holding device, such as a drinker holder. In specific embodiments, the holding device allows an improved retention of receptacles having a stem, a bowl, and a foot. According to specific embodiments, the holding device incorporates a holding plate that has a recess for receiving the receptacle in the region of the bowl, at least one peripheral region of the recess extending as far as an edge of the holding plate, the holding plate being arranged in the use position such that the recess is freely accessible. The holding plate with its recess thereby preferably functions as a drink holder. In this respect, the holding plate substantially extends in one plane, this plane being aligned as far as possible parallel to the surface of the aircraft seat in the use position. Thus, the drink holder has a very small installation space, so that it can be integrated inconspicuously into the design of the aircraft seat. The holding plate has a recess which is configured such that it can receive the receptacle in the region of the bowl. In the following, the term “receptacle” always relates to a receptacle having a bowl, a stem and a foot. The receptacle can thus be held positively by the recess near the centre of gravity of the receptacle. This means that the tilting moments acting on the receptacle are reduced and thus the receptacle is held securely in the recess. At least one peripheral region of the recess extends as far as the edge of the holding plate. Understood as the edge of the holding plate in this respect is a side face or a plurality of side faces which interconnect a first base surface of the holding plate with a second base surface of the holding plate. The holding plate thus has a certain height which is preferably less than 40 mm, more preferably less than 20 mm and particularly preferably less than 10 mm. The holding plate is preferably configured such that the length of the holding plate is greater than the height; in this respect, the ratio of length to height of the holding plate is preferably between 2 and 40, more preferably between 10 and 30. The stem, aligned substantially orthogonally to the holding plate, of the receptacle can be guided into the recess via the peripheral region. As soon as the stem is in the recess, the receptacle can be released so that the bowl is held by the recess. Preferably, the recess is formed by an opening in the holding plate and the peripheral region is formed by a groove which extends from the edge of the holding plate to the opening.

In an alternative embodiment, the shape of the recess can also merge into the shape of the peripheral region so that the peripheral region does not form a taper between the edge and the recess. Due to the small dimensions of the holding plate, said holding plate which is rotatably attached to the supporting platform can be moved into the parked position by simple mechanical means. In the use position, the holding plate is oriented such that the recess is freely accessible, i.e. the holding plate is held spatially only by the supporting platform. In specific embodiments, further holding means such as a base can be omitted thereby.

In specific embodiments, apart from the holding plate, the drink holder does not comprise any further elements that obstruct the accessibility of the recess. In the context of the invention, “freely accessible” is to be understood such that the recess is not restricted upwards or downwards. It is thereby possible for receptacles having relatively long stems and bowls of differing heights to be received in the recess. A further advantage of the aircraft seat according to the invention is provided by the fastening of the holding plate to the aircraft seat by the connecting device and the supporting platform. In addition to the ergonomically favourable movability of the holding plate, this fastening also produces a damping effect, so that only damped movements of the seat are transferred onto the holding plate. Movements by the passengers, for example while they are taking their seats in the aircraft, are at least partly compensated by this type of fastening, so that the receptacle remains in the rest position and the drink is prevented from spilling out of the receptacle.

In specific embodiments, the aircraft seat comprises at least one armrest, the movable supporting platform being arranged on or in the armrest. Due to the arrangement of the supporting platform on the armrest, it is possible to keep the holding plate in a position which can be easily reached by the passenger's hand.

The connecting device of the holding plate is preferably connected pivotally to the connecting socket of the supporting platform. In this respect, the rotational axis is oriented substantially orthogonally to the plane of the surface of the aircraft seat. Due to the pivoting movement of the holding plate with respect to the supporting platform and thereby with respect to the aircraft seat, the passenger can move the holding plate towards him so that he can place the receptacle in or remove it from the recess in an ergonomically favourable movement sequence. If the passenger wishes to leave his seat, he can move the holding plate away so that he is not prevented from standing up.

Immediately after the holding plate has been moved from the parked position into the use position, it is preferably in an initial position, being arranged therein such that the peripheral region is open through the recess substantially in an orthogonal direction to a longitudinal axis of the aircraft seat up to the edge of the holding plate. The initial position in this respect is the position adopted by the holding plate immediately after it has reached the use position. Thus, the initial position is preferably one of many use positions able to be adopted by the holding plate. The “longitudinal axis of the aircraft seat” is understood as meaning the straight-ahead viewing direction of the passenger sitting in the aircraft seat. The longitudinal axis of the aircraft seat usually runs parallel to the longitudinal axis of the aircraft. By arranging the peripheral region orthogonally to the longitudinal direction of the aircraft seat, the receptacle can be moved into or out of the recess only by a movement which is substantially orthogonal to the longitudinal axis of the aircraft. This embodiment is particularly advantageous, since during normal flight operation, the greatest forces act in the direction of the longitudinal axis of the aircraft. This advantageous arrangement of the peripheral region can thus prevent the receptacle from falling out as a result of these forces. Furthermore, the receptacle is thereby moved into and out of the recess in a direction transverse to the longitudinal axis of the aircraft seat, which is managed very easily by the occupant of the seat.

Preferably provided on the holding plate is a locking means, or locking mechanism, which can fully demarcate the peripheral region of the recess from the edge of the holding plate. In an open position of the locking mechanism, the receptacle can be moved into the recess via the peripheral region. The locking mechanism can then be moved into the closed position, so that it is no longer possible for the receptacle to be removed from the recess via the peripheral region. The foot of the receptacle is usually larger than the recess, so that the receptacle can also not be moved out of the recess by a vertical upwards movement. Thus, in the closed position of the locking mechanism, the receptacle is secured in all spatial directions and the recess is closed with respect to all peripheral directions. Thus, the receptacle can be prevented from flying out of the recess during turbulent flight phases and passengers can be protected from injury.

The locking mechanism can preferably be opened and closed by a rotational movement. The passenger or flight attendant can thus easily move the locking mechanism into a closed or open position. In this respect, the centre of rotation is preferably the recess.

A bevel is preferably provided on a contact surface of the holding plate against which the bowl rests when inserted. The bevel preferably has a round, convex or concave shape. The bevel is preferably provided on an edge of the recess which forms the transition to an upwardly directed base surface of the holding plate. Alternatively however, the bevel can also be provided on an edge of the locking mechanism, which edge forms the contact surface for the bowl; in this case, the locking mechanism is to be considered as a component of the holding plate. The bevel provides the advantage that the support surface between the bowl and the recess is increased and thereby the freedom of movement of the receptacle in the recess is reduced. Furthermore, due to the bevel the receptacle has to be raised slightly upwards in the vertical direction when it is removed from the recess, thereby providing a further safety advantage. Furthermore, the advantage is provided that the longitudinal axis of the receptacle is aligned orthogonally to the holding plate. The exact alignment of the receptacle in the holding plate is extremely important for a high-quality appearance, so that this alignment would have to be made personally by the flight attendant or passenger every time the receptacle is set down. Due to the bevel on the upper edge of the recess, the receptacle is automatically brought into a designated holding position, so that a manual alignment of the receptacle is unnecessary.

Furthermore, the shape of the bevel preferably corresponds to the receiving cross section of the receptacle. This is particularly advantageous if receptacles which all have an identical contour are going to be used in the cabin. Due to the shape of the bevel which corresponds to the surface of the bowl resting accordingly on the bevel, the receptacle can be held in a particularly safe manner in the recess.

According to embodiments of the invention, a holding device incorporates a holding plate, the holding plate having a recess for receiving the receptacle in the region of the bowl with at least one peripheral region of the recess extending as far as an edge of the holding plate, and the holding plate being aligned in the use position such that the recess is freely accessible.

In the following, embodiments of the invention will be described on the basis of preferred embodiments with reference to the accompanying figures. In the drawings:

### BRIEF DESCRIPTION OF DRAWINGS

FIG. 1 shows an aircraft seat with a supporting platform.

FIG. 2 shows an armrest with a drink holder according to an embodiment of the invention.

FIG. 3 shows a holding plate with a mechanical connecting device.

FIG. 4 shows a holding plate with a different alignment of a peripheral region of a recess.

FIG. 5 shows a holding plate with different shapes of the recess and of the peripheral region of the recess.

FIG. 6 shows a holding plate in which a recess and a peripheral region are formed together in a U shape.

FIG. 7 shows a holding plate with a first embodiment of a locking means, or locking mechanism.

FIG. 8 shows a holding plate with a second embodiment of a locking means, or locking mechanism.

FIG. 9 shows a holding plate with a third embodiment of a locking means, or locking mechanism.

FIG. 10 shows a holding plate with a bevel on the upper edge of the recess.

### DETAILED DISCLOSURE

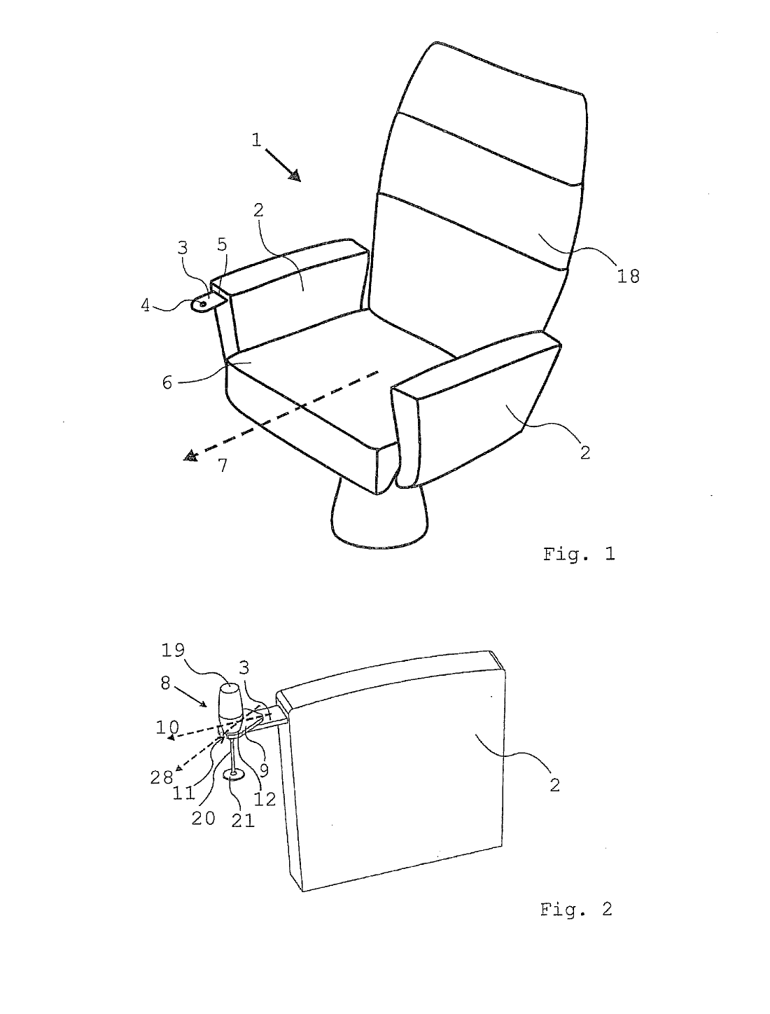

FIG. 1 shows an aircraft seat 1 with a seat surface 6, a seat back 18 and two armrests 2. In this respect, a longitudinal axis 7 of the seat 1 is parallel to the line of vision of a passenger who is sitting in the seat 1 and is looking straight ahead. Depending on the installation direction of the seat 1, the longitudinal axis 7 of the seat 1 accordingly runs parallel to the longitudinal axis of the aircraft in which the seat 1 is fitted.

Attached to the right-hand armrest 2 of the seat 1 is a supporting platform 3 which serves to connect a holding plate 9, shown in FIG. 2, to the seat 1. The supporting platform 3 and the holding plate 9 can be moved from a parked position into a use position and vice versa. In the use position, the holding plate 9 is aligned substantially parallel to the seat surface 6. In the parked position, the holding plate 9 and the supporting platform 3 are located in a mount 5 of the seat 1. In this embodiment, the mount 5 and the supporting platform 3 are arranged on the right-hand armrest 2 of the seat 1; alternatively, it is possible to arrange them on the left-hand armrest 2 or on another component of the seat 1.

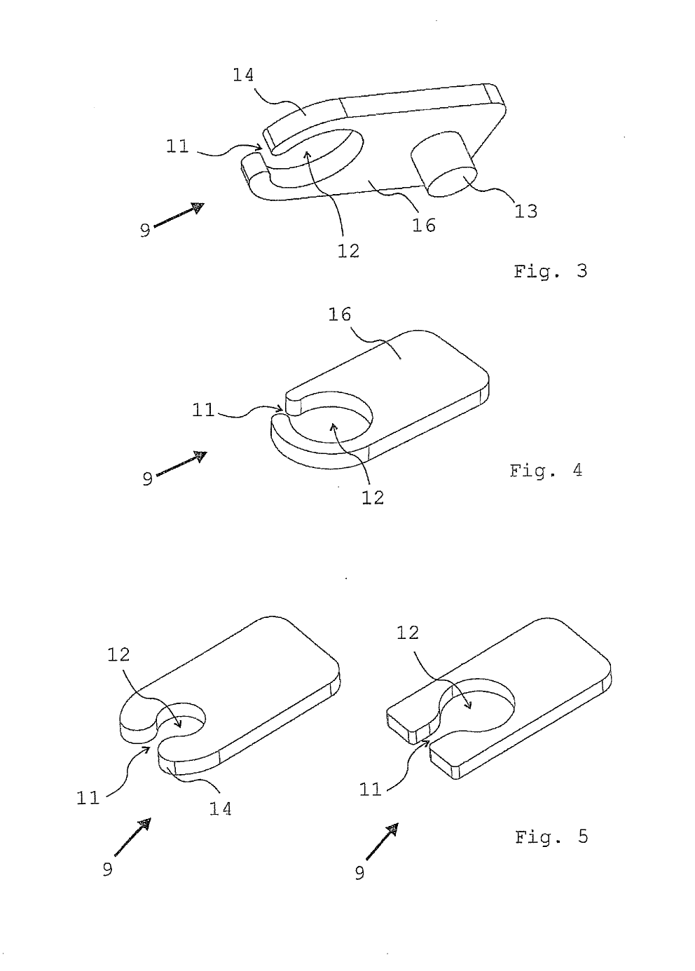

FIG. 2 is a schematic view of the right-hand armrest 2 of an aircraft seat 1, the attachment of the holding plate 9 being shown in detail. Analogously to the construction described here, the holding plate 9 can alternatively also be positioned on the left-hand armrest 2. The holding plate 9 is connected rotatably to the supporting platform 3. The rotational axis is preferably aligned substantially orthogonally to the plane of the seat surface 6. For this purpose, a connecting device 13 (see FIG. 3) is provided on the holding plate 9 and a mechanical connecting socket 4 is provided on the supporting platform 3. The connecting device 13 and the connecting socket 4 thereby preferably form a rotary joint. Preferably, the connecting device 13 is formed by a bolt and the connecting socket 4 is formed by a geometrically corresponding opening. Furthermore, the connecting device 13 and/or the connecting socket 4 are preferably arranged decentrally in a peripheral region of the holding plate 9 or of the supporting platform 3, thus allowing a swivelling movement of the holding plate 9 relative to the supporting platform 3 and thereby relative to the seat 1 with a simultaneous lateral offset movement of the recess 12.

Immediately after the holding plate 9 has moved out of the parked position into the use position, it adopts an initial position. The direction of the initial position is illustrated by way of example in FIG. 2 by arrow 10. However, it is also possible to set a different initial position. In FIG. 2, the holding plate 9 has been rotated to the left with respect to the initial position. The holding plate 9 is in the initial position when the longitudinal axis 28 of the holding plate 9 and the arrow 10 are substantially congruent.

The holding plate 9 has a recess 12 which is used to hold a receptacle 8 which has a bowl 19, a stem 20 and a foot 21. The foot 21 can also be formed as a counterweight without a planar standing surface, as a result of which the actual function of a foot 21, namely setting down on a substantially planar plane, is not provided, but instead merely a downwards shift in the centre of gravity is produced. Furthermore, in addition to typical receptacles for drinks, attractively designed flower vases, for example, can also be placed in the holding plate 9. The recess 12 is configured such that it is smaller than the diameter of the bowl 19; the bowl 19 is thus held by the recess 12 against a contact surface. The recess 12 is preferably smaller than the diameter of the foot 21. Thus, the receptacle 8 cannot be inserted into or removed from the recess 12 from above. For this reason and for reasons of a more ergonomic movement when the receptacle 8 is set down, the recess 12 is open in at least one direction; i.e. a peripheral region 11 of the recess 12 extends as far as an edge 14 of the holding plate 9. The edge 14 is the surface located between two base surfaces 16 of the holding plate 9. Via the peripheral region 11, it is thus possible to guide the stem 20 in a vertical position into the recess 12 of the horizontally oriented holding plate 9. In this respect, the recess 12 is dimensioned such that the contact surface between the recess 12 and the receptacle 8 is as close as possible to the centre of gravity of the receptacle 8, preferably above the centre of gravity. When calculating the centre of gravity of the receptacle 8, the empty receptacle 8 is preferably assumed, more preferably a full level of the receptacle 8 with a drink is assumed and particularly preferably a half-full level of the receptacle 8 is assumed. The tilting moment acting on the receptacle 8 can be reduced by approximating the contact surface to the centre of gravity of the receptacle 8. A stable system is present if the contact surface is above the centre of gravity of the receptacle 8 so that, after being deflected by a tilting moment, the receptacle 8 automatically moves back into the vertical set position.

The aircraft seat 1 is usually installed with its longitudinal axis 7 parallel to the longitudinal axis of the aircraft. In most cases, the installation direction of the aircraft seat 1 is selected such that the passenger is facing the direction of flight. In this installation direction, in the initial position of the holding plate 9, the peripheral region 11 is preferably presented in the direction of arrow 10 which is then oriented parallel to the longitudinal axis 7 of the aircraft, see for example FIGS. 2 and 3. This ensures that as a result of the accelerations which occur during the takeoff phase of the aircraft, the receptacle 8 cannot slip out of the recess 12 via the peripheral region 11. In a further preferred embodiment, the peripheral region 11 is arranged substantially laterally with respect to the longitudinal axis 7 of the aircraft seat, see FIG. 4. This measure can ensure that when the aircraft seat 1 is installed with the longitudinal axis 7 of the seat 1 aligned parallel to the longitudinal axis of the aircraft, irrespective of the backwards or forwards orientation of the line of vision, the peripheral region in the initial position is arranged orthogonally to the longitudinal axis of the aircraft. The receptacle 8 can thus only slip out as a result of lateral accelerations, which occur relatively rarely.

FIG. 5 shows two further embodiments of the holding plate 9. The left-hand illustration of FIG. 5 shows a relatively small recess 12. The edge 14 forms a rounded transition to the peripheral region 11. This has the advantage of facilitating the insertion of the stem 20 into the peripheral region 11 and thereby into the recess 12. The right-hand illustration of FIG. 5 shows a large recess 12 compared to the left-hand illustration, with an almost constant width of the peripheral region 11. The contact surface with the bowl 19 is displaced upwards compared to the left-hand illustration, due to the relatively large recess 12 of the peripheral region 11. In turn, this means that to remove the receptacle 8 from the recess 12, the receptacle 8 has to be lifted higher than in the case of the embodiment in the left-hand illustration of FIG. 5. The embodiment in the right-hand illustration of FIG. 5 thereby affords greater security against the receptacle 8 accidentally slipping out of the recess 12.

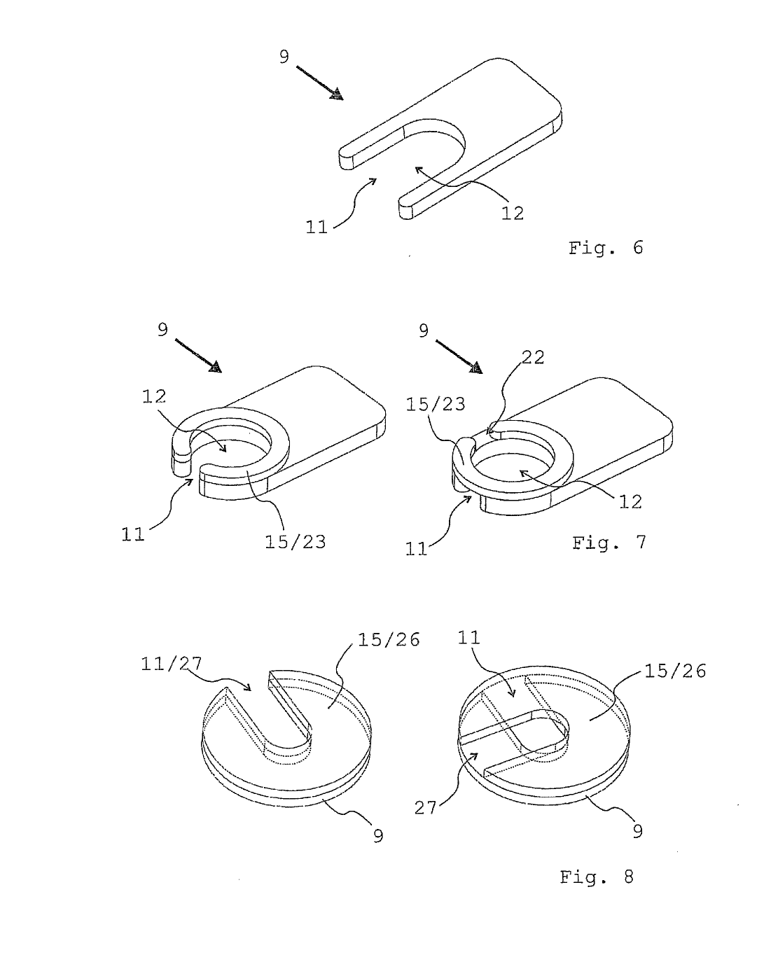

FIG. 6 shows a further embodiment of the holding plate 9 in which the peripheral region 11, together with the recess 12, forms a U shape. Thus, no tapering is provided between the recess 12 and the peripheral region 11, which would increase the risk of the receptacle 8 accidentally falling out. Furthermore, a purely horizontal movement suffices to remove the receptacle 8 from the recess 12; the receptacle 8 does not have to be lifted up.

FIG. 7 shows the holding plate 9 with a first embodiment of a locking means, or locking mechanism, 15. The locking means 15 is formed by a ring 23 having an opening 22, which ring 23 is preferably arranged rotatably on the upper base surface 16 of the holding plate 9. The arrangement of the ring 23 on the upper side of the holding plate 9 allows a simple handling when the ring 23 is rotated with respect to the holding plate 9. By rotating the ring 23, the opening 22 can be aligned congruently with the peripheral region 11; the locking means 15 is then in the open position (see FIG. 7, left). In the open position, the recess 12 is free via the peripheral region 11, so that the stem 20 of a receptacle 8 can be moved into or out of the recess 12. If the locking means 15 is rotated out of the open position to such an extent that the peripheral region 11 and the opening 22 are no longer congruent, then the locking means 15 is in the closed position (see FIG. 7, right). In this position, the stem 21 of the receptacle 8 can no longer be moved out of the recess 12. Since the size of the recess 12 is preferably selected to be smaller than the foot 21, the receptacle 8 cannot be pulled upwards out of the recess 12. Thus, in the closed position of the locking means 15, the receptacle 8 is secured against falling out in all spatial directions, thereby increasing safety onboard the aircraft. The ring 23 is preferably mounted in a guide arranged on the holding plate 9, a possible alternative being a magnetic mounting of the ring 23.

FIG. 8 shows a second embodiment of the locking means 15. Here, the locking means 15 is formed by a circular disc 26 which replicates the contour of the holding plate 9 and is mounted rotatably with respect to the holding plate 9. Provided in the disc 26 is a groove 27 which can be aligned with the peripheral region 11 and the recess 12 subject to the position of the disc 26; the locking means 15 is then in the open position (see FIG. 8, left). By rotating the disc 26 relative to the holding plate 9, it is possible to bring the locking means 15 into the closed position (see FIG. 8, right).

In the embodiments shown in FIGS. 7 and 8, the bowl 19 rests respectively against the ring 23 and against the disc 26 and not against the recess 12. Alternatively, the locking means 15 can also be arranged on the underside of the holding plate 9 so that the receptacle 8 rests, as before, directly against the holding plate 9.

FIG. 9 shows a further embodiment of the invention in which the locking means 15 is formed by a bar 24. The bar 24 is arranged on the edge 14 so that it can lock the peripheral region 11. The bar 24 can be moved by an actuating means 25 from an open position (see FIG. 9, left) into a closed position (see FIG. 9, right). In this embodiment, the bar 24 follows the circular contour of the edge 14 to be opened or closed. The bar 24 is thereby brought into the open position and into the closed position by a rotational movement with respect to the holding plate 9. Alternatively, the locking means 15 can also be configured such that a linear movement is produced.

It is also possible to operate the locking means 15 by an actuating means, or actuating mechanism. Consequently, the passenger does not personally have to perform the entire motion sequence of the locking means 15, but can conveniently control the locking means 15, for example by actuating a button. The locking means 15 then preferably moves via a spring-loaded mechanism or via an electronic actuator.

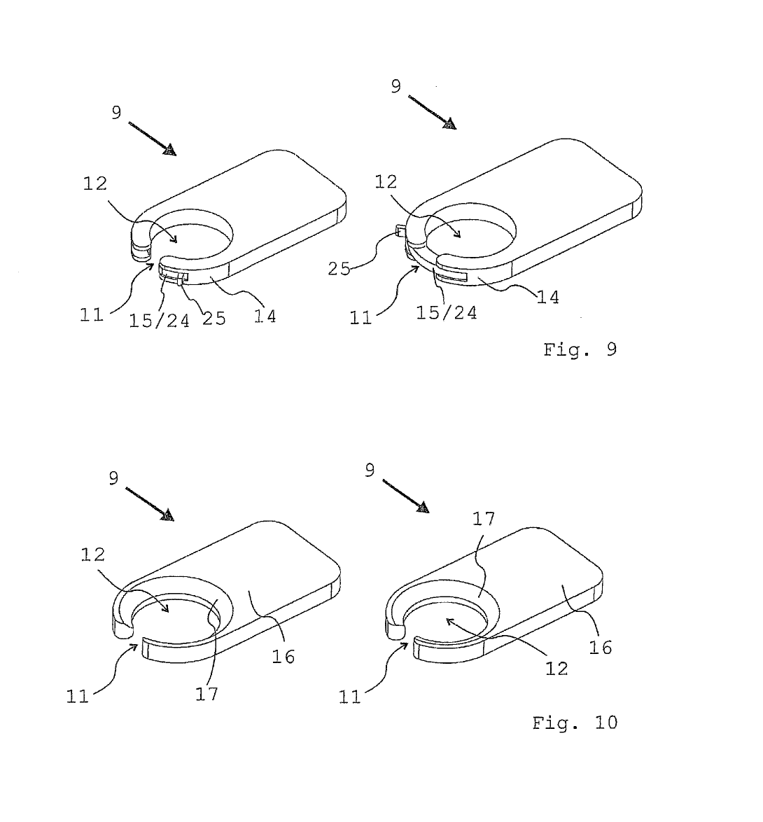

FIG. 10 shows an embodiment of the invention in which a bevel 17 is provided on the contact surface between the bowl 19 and the recess 12. The bevel provides an improved mounting of the bowl 19 in the recess 12 and thereby reduces the risk of the receptacle 8 falling out of the recess 12. The shape of the bevel 17 preferably corresponds to that of the respective contact surface of the bowl 19. For this, a round shape (see FIG. 10, left), a convex shape (see FIG. 10, right) or even a concave shape of the bevel 17 is possible.

Alternatively, in the embodiments shown in FIGS. 7 and 8, the bevel 17 can also be provided on the contact surface between the bowl 19 and the locking means 15.

Any combinations of the embodiments of the holding plate 9 and of the locking means 15, illustrated in FIGS. 3 to 10, are also to be explicitly added to the disclosure content of this application.

### EMBODIMENTS

### Embodiment 1

An aircraft seat having a holding plate for receiving receptacles which have a stem, a bowl and a foot, wherein

the aircraft seat has at least one mount and a movable supporting platform,

the supporting platform has a mechanical connecting socket,

on the supporting platform, the holding plate is connected by a mechanical connecting device to the connecting socket of the supporting platform,

the supporting platform is movable with the holding plate out of a parked position into a use position,

in the parked position, the supporting platform is held with the holding plate in the mount, wherein

the holding plate has a recess for receiving the receptacle in the region of the bowl,

at least one peripheral region of the recess extending as far as an edge of the holding plate,

the holding plate being arranged such that the recess is freely accessible in the use position.

### Embodiment 2

An aircraft seat according to Embodiment 1, wherein

the seat comprises at least one armrest,

the movable supporting platform being arranged on or in the armrest.

### Embodiment 3

An aircraft seat according to either one of the preceding Embodiments, wherein

the connecting device of the holding plate is connected pivotally to the connecting socket of the supporting platform.

### Embodiment 4

An aircraft seat according to any of the preceding Embodiments, wherein

immediately after moving from the parked position into the use position, the holding plate is in an initial position,

in the initial position, the holding plate being arranged such that the peripheral region is opened through the recess substantially in an orthogonal direction to a longitudinal axis of the aircraft seat as far as the edge of the holding plate.

### Embodiment 5

An aircraft seat according to any of the preceding Embodiments, wherein

provided on the holding plate is a locking means which can fully demarcate the peripheral region of the recess from the edge of the holding plate.

### Embodiment 6

An aircraft seat according to Embodiment 5, wherein

the locking means can be opened and closed by a rotational movement.

### Embodiment 7

An aircraft seat according to any of the preceding Embodiments, wherein

a bevel is provided on the contact surface of the holding plate, against which the bowl rests in the inserted state.

### Embodiment 8

An aircraft seat according to Embodiment 7, wherein

the shape of the bevel corresponds to the receiving cross section of the receptacle.

### Embodiment 9

A holding device having a holding plate for receiving receptacles which have a stem, a bowl and a foot, wherein

the holding device has a supporting platform with a mechanical connecting socket,

on the supporting platform, the holding plate is connected by a mechanical connecting device to the connecting socket of the supporting platform, wherein

the holding plate has a recess for receiving the receptacle in the region of the bowl,

at least one peripheral region of the recess extending as far as an edge of the holding plate,

the holding plate being aligned such that the recess is freely accessible in the use position.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

1. An aircraft seat, comprising:
at least one mount;
a supporting platform; and
a holding plate, wherein the holding plate is rotatably connected to the supporting platform, wherein the holding plate has a recess for receiving a receptacle having a stem, a bowl, and a foot in a region of the bowl, wherein the recess is open to an edge of the holding plate;
wherein the supporting platform with the holding plate rotatably connected to the supporting platform is configured to movably transition between a parked position and a use position, wherein in the parked position, the supporting platform with the holding plate rotatably connected to the supporting platform is held in the at least one mount, wherein in the use position, the supporting platform with the holding plate interconnected is extended out of the at least one mount,
wherein when the supporting platform with the holding plate rotatably connected is in the use position the recess is accessible to receive the receptacle having the stem, the bowl, and the foot.

2. The aircraft seat according to claim 1, wherein the supporting platform has a connecting socket, wherein the holding plate has a connecting device, wherein the holding plate is rotatably connected to the supporting platform by the connecting device rotatably connecting with the connecting socket.

3. The aircraft seat according to claim 1, further comprising:
at least one armrest, wherein a first armrest of the at least one armrest comprises a first mount of the at least one mount.

4. The aircraft seat according to claim 1, wherein after moving the supporting platform with the holding plate rotatably connected from the parked position into the use position, and before rotation of the holding plate with respect to the supporting platform, the holding plate is in an initial position,
wherein in the initial position, the holding plate is arranged such that a peripheral region of the recess is open to the edge of the holding plate in a direction substantially orthogonal to a longitudinal axis of the aircraft seat.

5. The aircraft seat according to claim 4, further comprising:
a lock, wherein the lock has an opened position and a closed position, wherein in the closed position the lock overlaps at least a portion of a cross-sectional area of the peripheral region of the recess.

6. The aircraft seat according to claim 5, wherein
the lock transitions from the open position to the closed position by a rotational movement.

7. The aircraft seat according to claim 1, wherein when the receptacle having the stem, the bowl, and the foot is received by the recess and inserted in an inserted state, the bowl of the receptacle contacts a contact surface of the holding plate,
wherein the holding plate comprises a bevel on the contact surface of the holding plate, wherein the bowl of the receptacle rests against the bevel when the receptacle is in the inserted state.

8. The aircraft seat according to claim 7, wherein a shape of the bevel corresponds to a receiving cross section of the receptacle, wherein the receiving cross section of the receptacle contacts the contact surface when the receptacle is in the inserted state.

9. A holding device, comprising:
a supporting platform; and
a holding plate, wherein the holding plate is rotatably connected to the supporting platform, wherein the holding plate has a recess for receiving a receptacle having a stem, a bowl, and a foot in a region of the bowl, wherein the recess is open to an edge of the holding plate;
wherein the recess comprises at least one peripheral region of the recess, wherein each peripheral region of the at least one peripheral region is open to the edge of the holding plate,
wherein in a use position, the holding plate is rotatably aligned with the supporting platform such that the recess is accessible for receiving the receptacle having the stem, the bowl, and the foot.

10. The holding device according to claim 9, wherein the supporting platform has a connecting socket, wherein the holding plate has a connecting device, wherein the holding plate is rotatably connected to the supporting platform by the connecting device rotatably connecting with the connecting socket.

11. The holding device according to claim 9, further comprising:
a lock, wherein the lock has an opened position and a closed position, wherein in the closed position the lock overlaps at least a portion of a cross-sectional area of the peripheral region of the recess.

12. The holding device according to claim 11, wherein
the lock transitions from the open position to the closed position by a rotational movement.

13. The holding device according to claim 9, wherein when the receptacle having the stem, the bowl, and the foot is received by the recess and inserted in an inserted state, the bowl of the receptacle contacts a contact surface of the holding plate,
wherein the holding plate comprises a bevel on the contact surface of the holding plate, wherein the bowl of the receptacle rests against the bevel when the receptacle is in the inserted state.

14. The holding device according to claim 13, wherein a shape of the bevel corresponds to a receiving cross section of the receptacle, wherein the receiving cross section of the receptacle contacts the contact surface when the receptacle is in the inserted state.

15. An aircraft, comprising:
a supporting platform; and
a holding plate, wherein the holding plate is rotatably connected to the supporting platform, wherein the holding plate has a recess for receiving a receptacle having a stem, a bowl, and a foot in a region of the bowl, wherein the recess is open to an edge of the holding plate;
wherein the recess comprises at least one peripheral region of the recess, wherein each peripheral region of the at least one peripheral region is open to the edge of the holding plate,
wherein in a use position, the holding plate is rotatably aligned with the supporting platform such that the recess is accessible for receiving the receptacle having the stem, the bowl, and the foot.

16. The aircraft according to claim 15, wherein the supporting platform has a connecting socket, wherein the holding plate has a connecting device, wherein the holding plate is rotatably connected to the supporting platform by the connecting device rotatably connecting with the connecting socket.

17. The aircraft according to claim 15, wherein the aircraft comprises at least one mount, wherein the supporting platform with the holding plate rotatably connected to the supporting platform is configured to movably transition between a parked position and the use position, wherein in the parked position, the supporting platform with the holding plate rotatably connected to the supporting platform is held in the at least one mount, wherein in the use position, the supporting platform with the holding plate interconnected is extended out of the at least one mount.

18. The aircraft according to claim 17, wherein the aircraft comprises an aircraft seat, wherein the aircraft seat comprises the at least one mount.

19. The aircraft according to claim 16, wherein after moving the supporting platform with the holding plate rotatably connected from the parked position into the use position, and before rotation of the holding plate with respect to the supporting platform, the holding plate is in an initial position,
wherein in the initial position, the holding plate is arranged such that a peripheral region of the recess is open to the edge of the holding plate in a direction substantially orthogonal to a longitudinal axis of the aircraft seat.

20. The aircraft according to claim 18, wherein the aircraft seat comprises:
at least one armrest, wherein a first armrest of the at least one armrest comprises a first mount of the at least one mount.
